(19) United States
(12) Patent Application Publication
(10) Pub. No.: US 2005/0112363 A1
(43) Pub. Date: May 26, 2005

(54) Biodegradable polymer compositions for a breathable film

(76) Inventor: Xin Ning, Alpharetta, GA (US)

Correspondence Address: KIMBERLY-CLARK WORLDWIDE, INC., 401 NORTH LAKE STREET, NEENAH, WI, 54956, US

(21) Appl. No.: 10/718,973

(22) Filed: Nov. 21, 2003

(51) Int. Cl. C08L 1/00; B32B 5/16

(52) U.S. Cl. 428/327; 428/515; 525/437

(57) ABSTRACT

The invention provides a biodegradable polymer composition for a breathable film which comprises a biodegradable polyester such as polylactic acid, a biodegradable copolyester such as an aliphatic/aromatic copolyester, and a filler such as calcium carbonate. These compounds are melt blended and film formed and the film is then stretched in a monoaxial or biaxial direction to enhance pore formation and hence also enhance the breathability of the film. The water vapor transmission rate (WVTR) of the film is typically greater than 3,000 grams per square meter per day so that the film is suitable for use in disposable articles such as wipes, diapers, training pants, absorbent underpants, adult incontinence garments, feminine hygiene products, medical garments, bandages and the like.

### FIELD

The present invention relates to compositions for manufacturing biodegradable polymer films, and more particularly to compositions for manufacturing biodegradable polymer films which are breathable.

### BACKGROUND OF THE INVENTION

Polymer films are useful in making a variety of disposable articles because they are relatively inexpensive to manufacture, can be strong, durable, flexible and soft, and can form a barrier to aqueous liquids such as water. Examples of such disposable products or articles include, but are not limited to, medical and health care products such as surgical drapes, gowns and bandages, protective workwear garments such as coveralls and lab coats, and infant, child and adult personal care absorbent articles such as diapers, training pants, disposable swimwear, incontinence garments and pads, sanitary napkins, wipes and the like. Other uses polymeric film materials include geotextiles. It is often highly desirable for polymeric films used in such product applications to be both liquid impervious and breathable.

It is known that breathable films can be prepared by blending an organic or inorganic incompatible filler with a polyolefin-based resin, which is then melted and film-formed. The resultant film is stretched so as to create small gaps between the polymer and the filler particles embedded in the polymer. This creates a tortuous path for gaseous molecules from one surface of the film to the other, allowing water vapor, for example, to escape. These breathable films are mainly used as liquid barriers in disposable personal care products, which are discarded immediately after use. However, the breathable films prepared from polyolefin-based resin cannot be degraded in the natural environment.

As landfills continue to fill up, there is an increasing demand for the incorporation of more recyclable and/or degradable components in disposable products, and the design of products that can be disposed of by means other than by incorporation into solid waste disposal facilities such as landfills. As such, there is a need for new materials for disposable absorbent products that generally retain their integrity and strength during use, but after such use, are more efficiently disposable. For example, the disposable absorbent product may be easily and efficiently disposed of by composting. Alternatively, the disposable absorbent product may be easily and efficiently disposed of to a liquid sewage system wherein the disposable absorbent product is capable of being degraded.

While it is possible to enhance the breathability and biodegradability of polymer films separately, enhancing the biodegradability of polymer films, without diminishing the breathability of the films, is difficult. For example, biodegradable films derived from copolyesters are known in the art. These films tend to be very flexible and ductile, with high elongation at break. However, due to the extremely ductile nature of these compounds, pore formation in such films is much less pronounced than in comparable polyethylene-based compositions, resulting in a water vapor transmission rate (WVTR) below 400 grams per square meter per 24 hours (g/m²/24 hours) in the stretched films. The breathability may be increased by subjecting these films to biaxial stretching, in which case a breathability of only 2,000-3,000 WVTR may be attained. This does not compare favorably with breathability values of up to 20,000 WVTR which can be attained in stretched films based on polyethylene/calcium carbonate compositions. These copolyester films are therefore not suitable for breathable personal care products, but are rather more suited for use as refuse bags, in packaging applications and the like.

Polylactic acid is also known to be completely biodegradable. However, films made from polylactic acid are fairly brittle due to the relatively high glass transition temperature (Tg) and high crystallinity of polylactic acid, and consequently these films show relatively low elongation at break. Additionally, compounding of polylactic acid with calcium carbonate filler generally results in a brittle compound with no extensibility. Polylactic acid films can be “plasticized” by using a lower molecular weight “plasticizer” such as lactic acid or lactide to improve the film's stretchability. A problem with these films is that the water soluble plasticizers may leach out of the films. This is especially relevant in hygiene articles where it is likely that the films will come into contact with an aqueous liquid. Consequently, lactic acid-based polymer films have many restrictions in use.

Blend compositions of a polylactic acid resin and an aliphatic polyester resin are also known. These compositions possess improved properties over those of the individual component resins. However, these compositions have not been used to make breathable films and/or films having pore formation. The films are therefore suitable for packaging and compost bags, where breathability is not an essential component of the films.

Thus, while biodegradable films are known, these films fail to provide the same or substantially similar properties of high permeability to water vapor as the currently used breathable (but not biodegradable) polyethylene films.

Accordingly, there remains a need for a composition which can be used to manufacture a biodegradable film which is also breathable, for use in making disposable articles of manufacture such as, for example, personal care items, absorbent products, health care products, medical fabrics and the like.

### SUMMARY OF THE INVENTION

The present invention provides a composition for a biodegradable, breathable film and a biodegradable, breathable film, as well as laminates and disposable articles comprising the film. The new composition includes a biodegradable polyester, a biodegradable copolyester and at least one filler. The polyester, copolyester and filler may be melt-blended and film-formed, and the resultant film may subsequently be stretched.

A film prepared from the composition, once stretched, typically has a water vapor transmission rate of at least 800 grams per square meter per 24 hours and is breathable. The composition may be comprise a compatibilizer and the compatibilizer may be such as a fatty acid, unsaturated fatty acid, amide thereof, silane coupling agents, alkyl titanate, and so forth. The compatibilizer may be added to the composition during the blending step.

The composition may include polylactic acid as the polyester, copolyesters of aliphatic/aromatic acids as the copolyester, and calcium carbonate as an inorganic filler. Examples of polylactic acid are D-polylactic acid, L-polylactic acid, D,L-polylactic acid, meso-polylactic acid, and any combination of D-polylactic acid, L-polylactic acid, D,L-polylactic acid and meso-polylactic acid.

Typically, the composition has from about 30 weight percent to about 70 weight percent polyester and copolyester and from about 70 weight percent to about 30 weight percent filler. Desirably, the composition has from about 40 weight percent to about 55 weight percent polyester and copolyester, and from about 60 weight percent to about 45 weight percent filler.

The weight ratio of polyester to copolyester in the composition and film may be from about 1:9 to about 9:1.

### BRIEF DESCRIPTION OF THE DRAWINGS

FIG. 1 is an illustration in partial cut away view of a laminate material comprising the breathable and biodegradable film of the invention.

FIG. 2 is a perspective view of a disposable diaper comprising the breathable and biodegradable film of the invention.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of.”

As used herein, the term “biodegradable” when used to describe a material, means that a material that degrades from exposure to air and/or water, or from the action of naturally occurring microorganisms such as bacteria, fungi, and algae.

As used herein, the term “breathability” refers to the water vapor transmission rate (WVTR) of an area of film. Breathability is measured in grams of water per square meter per day.

As used herein, the term “breathable” refers to a film having a WVTR of at least 800 grams per square meter per 24 hours.

As used herein, the term “copolymer” generally includes but is not limited to, block, graft, random and alternating copolymers, and blends and modifications thereof.

As used herein, the term “filler” is meant to include particulates and other forms of materials which can be added to a film blend and which will not chemically interfere with or adversely affect an extruded film, but which are able to be substantially uniformly dispersed throughout the film. Fillers known in the art include particulate inorganic materials such as for example talc, calcium carbonate, barium carbonate, magnesium carbonate, magnesium sulfate, titanium dioxide, mica, clays, kaolin, diatomaceous earth and the like, and organic particulate materials such as powdered polymers for example TEFLON and KEVLAR, and wood and other cellulose powders.

As used herein, the term “personal care products” means personal hygiene oriented products such as wipes, diapers, training pants, absorbent underpants, adult incontinence products, feminine hygiene products, and so forth.

### DETAILED DESCRIPTION OF THE INVENTION

The invention provides a composition having a biodegradable polyester, a biodegradable copolyester and a filler. Films made from such compositions are expected to have good mechanical and biodegradable properties compared to films made from either the polyester or copolyester alone.

As both the polyester and copolyester are esters in chemical nature, they may be compatibilized or be made miscible through a chemical change in molecular structure due to trans-esterification during a melt-blending process, resulting in a compound with crystallinity and glass transition temperature (Tg) values between those of the polyester and copolyester. The resulting compound therefore has a more balanced stretch behavior than either the ductile copolyester or the brittle polyester and is thus more prone to void formation when stretched, the void formation process being essential to breathable film manufacturing.

A film formed from the compound provides good water vapor permeability while still acting as a barrier to the passage of liquids. As a result, while not meaning to be limited to the specific uses as herein specified, the film of the present invention has particular use as liners or backing material for articles of manufacture such as personal care absorbent products (including diapers, sanitary napkins, training pants and incontinence garments), health care products, medical fabrics and the like.

In a specific example of the invention, the biodegradable film comprises polylactic acid, an aliphatic/aromatic copolyester, and calcium carbonate.

Other additives and ingredients may be added to the film layer provided they do not seriously interfere with the ability of the film to breath or biodegrade. For example, a compatibilizer such as a fatty acid, unsaturated fatty acid, amide thereof, silane coupling agent, alkyl titanate, and so forth may be added to the mixture. Colorants, reinforcements and other types of fillers can also be added.

Suitable copolyesters are those having good physical properties and biodegradability. Such copolyesters are disclosed in European Pat. No. EP 1 106 640 and European Pat. No. EP 1 108 737, both to Chung et al., in which copolyesters are prepared by the reaction of (i) 0.1 weight percent to 30 weight percent of an aromatic-aliphatic prepolymer having an average molecular weight of from 300 to 30,000; (ii) 40 weight percent to 71 weight percent of one or more aliphatic or alicyclic dicarboxylic acids or anhydrides; and (iii) 29 weight percent to 60 weight percent of one or more aliphatic or alicyclic glycerols. Specific examples of suitable aliphatic/aromatic copolyesters are ENPOL® G8060 and IRE® 8000 from Ire Chemical Ltd of Seoul, South Korea, and EASTAR® from Eastman Chemical of Kingsport, Tenn., USA.

The polylactic acid can be made from lactic acid (lactate). Lactic acid is a natural molecule that is widely employed in foods as a preservative and a flavoring agent. It is the main building block in the chemical synthesis of the polylactide family of polymers. Although it can be synthesized chemically, lactic acid is procured principally by microbial fermentation of sugars such as glucose or hexose. These sugar feed stocks can be derived from potato skins, corn, and dairy wastes. The lactic acid monomers produced by fermentation are then used to prepare polylactide polymers.

As used herein, the term “polylactic acid” includes any one or more of four morphologically distinct polylactic acid polymers: D-polylactic acid, L-polylactic acid, D,L-polylactic acid, and meso-polylactic acid. D-polylactic acid and L-polylactic acid are dextro-polylactic acid and levo-polylactic acid, respectively, and both of them are optically active polymers that rotate a light vector when transmitted through the polymer. D,L-polylactic acid is a racemic polymer, i.e., a copolymer of D-polylactic acid and L-polylactic acid having a well-defined conformation of D- and L-polylactic acid units. Meso-polylactic is a random copolymer of D-polylactic and L-polylactic.

The copolyester may also be a polylactic acid-based polymer having at least 50% by weight of polylactic acid.

A suitable polylactic acid is a naturally-derived polylactic acid such as NATUREWORKS® 4042D polylactic acid from Cargill Dow Polymers LLC of Minnetonka, Minn., USA.

The calcium carbonate may be obtained from English China Clay (trading as Imerys) of Roswell, Ga., USA, and also from Omya of Florence, Vt., USA.

The polyester and copolyester are typically present in a ratio of from 9:1 to 1:9, by weight, with respect to each other.

Generally, on a dry weight basis, based upon the total weight of the composition, the composition includes from about 30 to about 70 weight percent of the polyester and copolyester, and from about 70 to about 30 weight percent filler. More particularly, the composition includes from about 40 to about 55 weight percent of the polyester and copolyester, and from about 60 to about 45 weight percent filler.

The filler is typically in particulate form and has somewhat of a spherical shape, with average particle sizes in the range of about 0.1 to about 7 micrometers, and more particularly in the range of about 0.5 to about 2.6 micrometers. Examples of inorganic fillers include calcium carbonate, magnesium carbonate, barium carbonate, magnesium sulfate, barium sulfate, calcium sulfate, zinc oxide, magnesium oxide, calcium oxide, titanium oxide, barium oxide, aluminum oxide, aluminum hydroxide, hydroxyapatite, silica, mica, talc, kaolin, clay, glass powder, asbestos powder, zeolite and acid clay. Particularly desirable inorganic fillers are calcium carbonate, magnesium oxide, barium sulfate, silica and acid clay.

The polyester, copolyester and filler may be mixed in appropriate proportions given the ranges outlined above and then compounded and extruded into a film layer using any one of a variety of film-producing processes known to those of ordinary skill in the art, including casting and blowing. The composition may alternatively be pelletized prior to the film-forming step, instead of the film being obtained directly from the extruder. The extrusion temperature may desirably be in the range of from about 180 degrees Celsius to about 270 degrees Celsius, and more desirably in the range of from about 200 degrees Celsius to about 250 degrees Celsius, for example, about 220 degrees Celsius.

The film may then be stretched in a monoaxial direction to obtain a stretch ratio of from about less than 1× to about 5× in the machine direction (MD), for example about 3×, as detailed more fully in U.S. Pat. Nos. 5,695,868 and 5,855,999 both to McCormack, incorporated herein by reference in their entireties, in order to make it porous. The film may optionally also be stretched in a biaxial direction (i.e. in both longitudinal and lateral directions) so as to obtain a stretch ratio which is desirably in the range of from less than 1× by 1× to about 3× by 3× in the cross-direction (CD), for example, about 2× by 2×. The stretching temperature may be in the range of from 30 degrees Celsius to about 100 degrees Celsius.

In order to provide uniform breathability as reflected by the water vapor transmission rate of the film, the filler should be substantially uniformly dispersed throughout the polymer blend and, consequently, throughout the film itself.

For purposes of the present invention, a film is “breathable” if it has a water vapor transmission rate (WVTR) of at least 800 grams per square meter per 24 hours as calculated using the MOCON® test method, which is described in more detail below. The WVTR of the film of this invention is within the range from about 800 to about 15,000 grams per square meter per 24 hours, is more desirably within the range of 2,000 to 15,000 grams per square meter per 24 hours, and is even more desirably at least about 3,000 grams per square meter per 24 hours.

The actual crystallinity and Tg values of the film will depend on the particular ratio of the polyester and copolyester used to make the film. For example, the blend Tg could be from about −50 degrees Celsius to about 60 degrees Celsius, and the crystallinity could be from about 5 percent to about 50 percent, depending on the actual composition of the film.

Generally, once the film is formed, it will have a weight per unit area of less than about 100 grams per square meter, and after stretching and thinning its weight per unit area will be less than about 35 grams per square meter, and more desirably less than about 18 grams per square meter.

The thickness of the film may differ depending upon its uses and is generally in the range of from about 10 to about 300 micrometers.

The films have an elongation at break of at least about 10 percent and, more desirably at least about 200 percent.

In addition, the films may have a toughness of at least about 10 MJ/cubic meter, and up to about 120 MJ/cubic meter or more.

MOCON® Water Vapor Transmission Rate Test:

A suitable technique for determining the water vapor transmission rate (WVTR) value of a material is the test procedure standardized by INDA (Association of the Nonwoven Fabrics Industry), number IST-70.4-99, entitled “STANDARD TEST METHOD FOR WATER VAPOR TRANSMISSION RATE THROUGH NONWOVEN AND PLASTIC FILM USING A GUARD FILM AND VAPOR PRESSURE SENSOR” which is incorporated by reference herein. The INDA procedure provides for the determination of WVTR, the permeance of the film to water vapor and, for homogeneous materials, water vapor permeability coefficient.

The INDA test method is well known and will not be set forth in detail herein. However, the test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the PERMATRAN-W® model 100K manufactured by Modern Controls, Inc (MOCON®) of Minneapolis, Minn., USA. A first test is made of the WVTR of the guard film and air gap between an evaporator assembly that generates 100 percent relative humidity. Water vapor diffuses through the air gap and the guard film and then mixes with a dry gas flow which is proportional to water vapor concentration. The electrical signal is routed to a computer for processing. The computer calculates the transmission rate of the air gap and guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. The computer then calculates the transmission rate of the combination of the air gap, the guard film, and the test material.

This information is then used to calculate the transmission rate at which moisture is transmitted through the test material according to the equation:
TR⁻¹_{test material}=TR⁻¹_{test material, guardfilm, airgap}−TR⁻¹_{guardfilm, airgap}

The calculation of the WVTR uses the formula:
WVTR=Fρₛₐₜ(T)RH/Apₛₐₜ(T)(1−RH))
where:
F=the flow of water vapor in cc/min,
ρₛₐₜ(T)=the density of water in saturated air at temperature T,
RH=the relative humidity at specified locations in the cell,
A=the cross sectional area of the cell, and
pₛₐₜ(T)=the saturation vapor pressure of water vapor at temperature T.

The invention will now be described in more detail by way of the following non-limiting examples, which are designed to illustrate particular aspects of the invention and teach one of ordinary skill in the art how to carry out the invention.

### EXAMPLES

### Example 1

Five parts of a naturally occurring polylactic acid, NATUREWORKS® 4042D from Cargill Dow Polymers LLC, may be combined with 45 parts of a copolyester, ENPOL® 8060 from Ire Chemical Ltd, and 50 parts of an inorganic filler, OMYA® 2SST calcium carbonate from Omya.

NATUREWORKS® 4042D polylactic acid has a melting point of 135 degrees Celsius, a glass transition temperature (Tg) of 52 degrees Celsius and elongation at break of 160 percent in the machine direction (MD) and 100 percent in the cross-direction (CD).

ENPOL® G8060 copolyester is a fully biodegradable aromatic/aliphatic copolyester having a melting point of 127 degrees Celsius, a melt index of 1.4-5 g/10 min at 190 degrees Celsius and 2160 g load, and elongation at break of 250 percent (MD) and 750 percent (CD) (ASTM D638).

The typical particle diameter of OMYA® 2SST calcium carbonate is about 2 micrometers.

The mixture may then be mixed at room temperature with a blender such as a HENSCHEL® mixer, or the compounds may be independently metered into feeders of a compounding extruder.

Compounding may take place in a twin screw extruder. Twin screw extruders such as a Haake RHEOCORD®90, available from Haake GmbH of Karlsautte, Germany, or a BRABENDER® twin screw mixer (cat no 05-96-000) available from Brabender Instruments of South Hackensack, N.J., USA, or other comparable twin screw extruders, are well suited to this task.

Melt extrusion temperature may desirably be in the range of from about 180 degrees Celsius to about 270 degrees Celsius, and more desirably in the range of from about 200 degrees Celsius to about 250 degrees Celsius.

The compound may then be processed in a film casting process into films of about 20 micrometer thickness. The film may then be placed into a conventional machine direction orientation unit (MDO), such as that manufactured by the Marshall and Williams Company, where it is stretched in the machine direction (MD) as described in U.S. Pat. No. 5,695,868 and U.S. Pat. No. 5,855,999, both to McCormack, so as to obtain a stretched film with a 3× MD stretch ratio. The stretching is desirably performed in an oven or over heated rolls so that the stretch temperature can be controlled, and the desired stretch temperature is in the range of from about 30 degrees Celsius to about 100 degrees Celsius. After stretching, heat setting may be carried out in order to enhance form stability of the pores.

The stretch ratio is defined as:
Stretch %=(final film length−original length)/original length×100

### Example 2

The process for manufacturing the film set out in Example 1 may be repeated, with the difference being that the proportion of inorganic filler added to the mixture is 50 weight percent. The polylactic acid and copolyester, in ratios of from about 1:9 to about 9:1 weight percent with respect to each other, make up the other 50 weight percent of the mixture. Thus:
(a) 10 parts of NATUREWORKS® 4042D polylactic acid from Cargill Dow Polymers are combined with 40 parts of ENPOL® 8060 copolyester from Ire Chemical Ltd and 50 parts of OMYA® 2SST calcium carbonate filler from Omya.
(b) 20 parts of NATUREWORKS® 4042D polylactic acid are combined with 30 parts of ENPOL® 8060 copolyester and 50 parts of OMYA® 2SST calcium carbonate.
(c) 25 parts of NATUREWORKS® 4042D polylactic acid are combined with 25 parts of ENPOL® 8060 copolyester and 50 parts of OMYA® 2SST calcium carbonate.

### Example 3

The process described in Example 1 may again be repeated, the difference being that the inorganic filler is added to the mixture so that it forms 55 percent of the mixture. The polylactic acid and copolyester, in ratios of from about 1:9 to about 9:1 weight percent with respect to each other, make up the other 45 weight percent of the mixture. Thus:
(a) 5 parts of a naturally-derived polylactic acid, NATUREWORKS® 4042D from Cargill Dow Polymers LLC, are combined with 40 parts of a copolyester, ENPOL® 8060 from Ire Chemical Ltd, and 55 parts of an inorganic filler, OMYA® 2SST calcium carbonate from Omya.
(b) 10 parts of NATUREWORKS® 4042D polylactic acid are combined with 35 parts of ENPOL® 8060 copolyester and 55 parts of OMYA® 2SST-calcium-carbonate.
(c) 20 parts of NATUREWORKS® 4042D polylactic acid are combined with 25 parts of ENPOL®8060 copolyester and 55 parts of OMYA® 2SST calcium carbonate.

### Example 4

The process for manufacturing the film set out in Example 1 may once again be repeated, with the difference being that the proportion of inorganic filler added to the mixture is 45 weight percent. The polylactic acid and copolyester, in ratios of from about 1:9 to about 9:1 weight percent with respect to each other, make up the other 55 weight percent of the mixture. Thus:
(a) 5 parts of a naturally-derived polylactic acid, NATUREWORKS® 4042D from Cargill Dow Polymers LLC, are combined with 50 parts of a copolyester, ENPOL® 8060 from Ire Chemical Ltd, and 45 parts of an inorganic filler, OMYA® 2SST calcium carbonate from Omya.
(b) 10 parts of NATUREWORKS® 4042D polylactic acid are combined with 45 parts of ENPOL® 8060 copolyester and 45 parts of OMYA® 2SST calcium carbonate.
(c) 20 parts of NATUREWORKS® 4042D polylactic acid are combined with 35 parts of ENPOL® 8060 copolyester and 45 parts of OMYA® 2SST calcium carbonate.

### Example 5

Five parts of a naturally-derived polylactic acid, NATUREWORKS® 4042D from Cargill Dow Polymers LLC, may be combined with 45 parts of a copolyester, ENPOL® 8060 from Ire Chemical Ltd, and 50 parts of an inorganic filler, OMYA® 2SST calcium carbonate from Omya.

The mixture may then be melt compounded in a twin screw extruder at 220 degrees Celsius and processed in a film casting process into films of about 20 micrometer thickness. The film may then be placed into a machine direction orientation unit (MDO) and stretched in the machine direction (MD) so as to obtain stretched films with from about 1× to about 5× MD stretch ratios. The stretching is performed in an oven so that the stretch temperature can be controlled, and the desired stretch temperature is in the range of from about 30 degrees Celsius to about 100 degrees Celsius. After stretching, heat setting is carried out in order to enhance form stability of the pores.

The stretch ratio is defined as:
Stretch %=(final film length−original length)/original length×100

### Example 6

Five parts of a naturally-derived polylactic acid, NATUREWORKS® 4042D from Cargill Dow Polymers LLC, may be combined with 45 parts of a copolyester, ENPOL®8060 from Ire Chemical Ltd and 50 parts of an inorganic filler, OMYA® 2SST calcium carbonate from Omya.

The mixture may then be mixed for from about 5 to about 30 minutes at room temperature with a blender, melt compounded in a twin screw extruder at 220 degrees Celsius and processed in a film casting process into films of about 20 micrometer thickness.

The films may then be run through a set of intermeshing groove rolls. The engagement of the rolls creates cross-directional (CD) extension, the extent of which is measured by the length gain in CD direction. This stretched film is further turned about 90 degrees and fed through the groove rolls again to gain biaxial extension. The stretching is performed in an oven so that the stretch temperature can be controlled, and the desired stretch temperature is in the range of from about 20 degrees Celsius to about 100 degrees Celsius. After stretching, heat setting is carried out in order to enhance form stability of the pores.

The stretch ratio is defined by percentage length gain in both directions, and the CD stretch ratio may desirably be in the range of from less than 1× by 1× to about 3× by 3×, for example, about 2× by 2×.

### Example 7

The experiment of Example 1 may again be repeated, except that a different copolyester and/or inorganic filler is used as follows:
(a) 5 parts of a naturally-derived polylactic acid, NATUREWORKS® 4042D from Cargill Dow Polymers LLC, are combined with 45 parts of a copolyester, IRE® 8000 from Ire Chemical Ltd, and 50 parts of an inorganic filler, OMYA® 2SST calcium carbonate, available from Omya.
(b) 5 parts of NATUREWORKS® 4042D polylactic acid from Cargill Dow Polymers LLC are combined with 45 parts of ENPOL® 8060 copolyester from Ire Chemical Ltd and 50 parts of a calcium carbonate filler from English China Clay.

### Example 8

Five parts of a naturally-derived polylactic acid, NATUREWORKS® 4042D from Cargill Dow Polymers LLC may be combined with 45 parts of a copolyester, ENPOL®8060 from Ire Chemical Ltd, about 49 parts of an inorganic filler, OMYA® 2SST calcium carbonate from Omya and less than 1 part of a compatibilizing agent, ERUCAMIDE® 95 percent from Darwin Chemical Co., Plantation, Fla., USA.

The composition may then be mixed for from about 5 to about 30 minutes at room temperature with a blender, melt compounded in a twin screw extruder at 220 degrees Celsius and processed in a film casting process into films of about 20 micrometer thickness. The film may then be placed into a machine direction orientation unit (MDO) and stretched in the machine direction (MD) so as to obtain a stretched film with a 3× MD stretch ratio. The stretching is performed in an oven so that the stretch temperature can be controlled, and the desired stretch temperature is in the range of from about 30 degrees Celsius to about 100 degrees Celsius. After stretching, heat setting is carried out in order to enhance form stability of the pores.

The stretch ratio is defined as:
Stretch %=(final film length−original length)/original length×100

Compared to polylactic acid on its own or a copolyester on its own, the new tertiary blends of polylactic acid, a copolyester and a filler are expected to provide a large increase in elongation (for example, from 5 percent to 500 percent), toughness enhancement (from less than 10 MJ per cubic meter to more than 120 MJ per cubic meter), pronounced pore formation and, most importantly, improved breathability.

A biodegradable film may therefore be produced having a high WVTR value (greater than 3,000 grams per square meter per 24 hours), and hence good breathability. Such breathable and biodegradable films are highly useful for use in single-use or disposable articles and products where a fluid impervious barrier is required but the barrier is also desirably breathable. Examples of such products include, but are not limited to, medical and health care products such as surgical drapes, gowns and bandages, protective workwear garments such as coveralls and lab coats, and infant, child and adult personal care absorbent articles such as diapers, training pants, disposable swimwear, incontinence garments and pads, sanitary napkins, wipes and the like. Other uses for such breathable and biodegradable polymeric film materials may include geotextiles. While not described in detail herein, various additional potential processing and/or finishing steps known in the art such as aperturing, slitting, further stretching, treating, or lamination of the breathable and biodegradable polymeric film materials with other films or with nonwoven web layers, may be performed without departing from the spirit and scope of the invention.

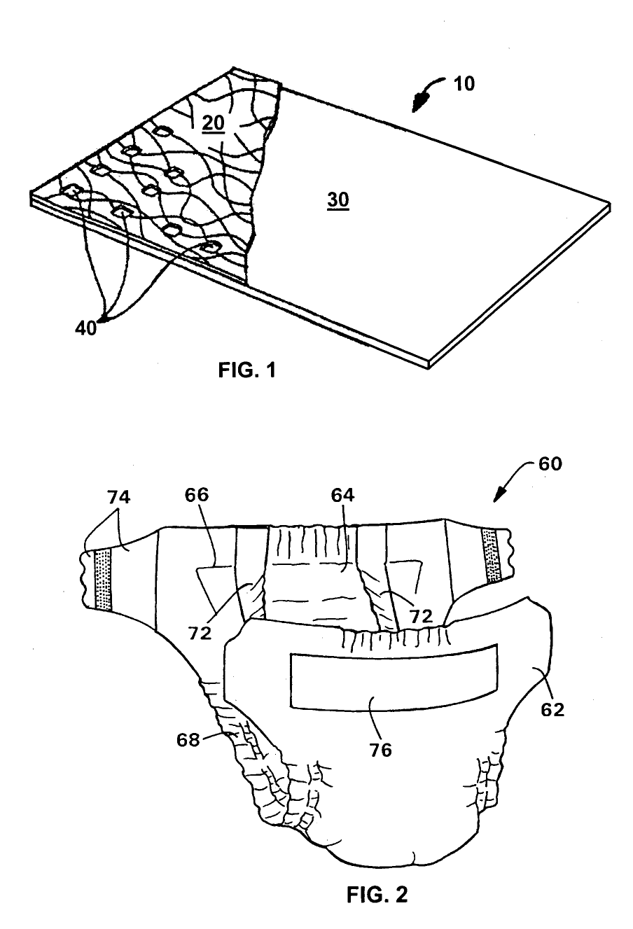

Examples of lamination of the breathable and biodegradable polymeric film materials with other films or nonwoven layers include laminate materials having two or more layers, such as the exemplary bi-layer laminate material shown in FIG. 1. Nonwoven fabrics or webs have been formed from many processes such as for example, meltblowing processes, spunbonding processes, airlaying processes, and carded web processes. FIG. 1 demonstrates a laminate material which is a laminate of the breathable and biodegradable polymeric film with a nonwoven web layer such as, for example, a spunbond web layer bonded to the film. Spunbond nonwoven webs are well known in the art and will not be described herein in detail. Briefly, spunbond refers to a nonwoven fiber or filament material of small diameter filaments that are formed by extruding molten thermoplastic polymer as filaments from a plurality of capillaries of a spinneret. The extruded filaments are cooled while being drawn by an eductive or other well known drawing mechanism. The drawn filaments are deposited or laid onto a forming surface in a generally random manner to form a loosely entangled filament web, and then the laid filament web is subjected to a bonding process to impart physical integrity and dimensional stability. The production of spunbond fabrics is disclosed, for example, in U.S. Pat. Nos. 4,340,563 to Appel et al., U.S. Pat. No. 3,692,618 to Dorschner et al., and U.S. Pat. No. 3,802,817 to Matsuki et al., all of which are incorporated herein by reference in their entireties. Typically, spunbond fibers or filaments have a weight-per-unit-length in excess of about 1 denier and up to about 6 denier or higher, although both finer and heavier spunbond filaments can be produced. In terms of filament diameter, spunbond filaments often have an average diameter of larger than 7 microns, and more particularly between about 10 and about 25 microns, and up to about 30 microns or more.

FIG. 1 is a schematic only, simply illustrative of one of the types of laminates intended. Generally, such multi-layer nonwoven-film laminate materials have a basis weight of from about 3 to about 400 grams per square meter, or more particularly from about 15 grams per square meter to about 150 grams per square meter. As shown in FIG. 1, the b-layer laminate material is generally designated 10 and comprises breathable and biodegradable polymeric film layer 30 to which is attached a nonwoven web layer 20. As is known to one skilled in the art, such laminates may be laminate bonded by, for example, adhesive bonding, ultrasonic bonding, or thermal bonding such as thermal point or “spot” bonding. Additionally shown in FIG. 1 are bond points 40 such as may be made by a thermal spot bonding process, which bond or mate the two materials of the laminate together at spaced apart locations in a pattern of spots. Adhesive bonding as is known in the art may be particularly advantageous where the component layers of the laminate to be bonded together do not thermally bond well together, as where the components have disparate melting points or softening temperatures. In addition, it should be noted that the breathable and biodegradable films may also be laminated as part of a tri-laminate material such as a nonwoven/film/nonwoven laminate material. Such a tri-laminate material may be particularly desirable in applications, such as for example in disposable medical fabrics, where it is useful to have a more cloth-like layer on both sides of the breathable barrier film layer.

As was mentioned, the breathable and biodegradable polymeric film materials of the invention are also highly suitable for use in personal care absorbent articles. Turning to FIG. 2 there is shown an exemplary personal care article such as the diaper 60. Diaper 60, as is typical for most personal care absorbent articles, includes a liquid permeable body side liner 64, i.e., a body-facing or inner side, and a liquid impermeable outer cover 62, i.e., a non-body facing or outer side. Various woven or nonwoven fabrics can be used for body side liner 64 such as a spunbond nonwoven web of polyolefin fibers, or a bonded carded web of natural and/or synthetic fibers. Liner 64 may also beneficially be a spunbonded web or carded web material comprising the multicomponent fibers of invention. Outer cover 62 is formed of a thin liquid barrier material such as for example the breathable and biodegradable polymeric film materials of the invention. Such a polymer film material outer cover may be embossed and/or matte finished to provide a more aesthetically pleasing appearance, or may be a laminate formed of the breathable and biodegradable film and a woven or nonwoven web material, such as was described above, to provide a more aesthetically pleasing feel and sound or more “cloth-like” characteristics.

Disposed between liner 64 and outer cover 62 is an absorbent core 66 formed, for example, of a blend of hydrophilic cellulosic wood pulp fluff fibers and highly absorbent gelling particles (e.g., superabsorbent material). Absorbent core 66 may further comprise thermoplastic binder fibers as are known in the art. Diaper 60 may further include optional containment flaps 72 made from or attached to body side liner 64. Suitable constructions and arrangements for such containment flaps are described, for example, in U.S. Pat. No. 4,704,116 to Enloe, incorporated herein by reference in its entirety. Still further, the diaper 60 can optionally include additional elements known to those skilled in the art, including but not limited to, elasticized leg cuffs, elastic waist band, and so forth.

To secure the diaper 60 about the wearer, the diaper will have some type of fastening means attached thereto. As shown in FIG. 2, the fastening means is a hook and loop fastening system including hook elements 74 attached to the inner and/or outer surface of outer cover 62 in the back waistband region of diaper 60 and one or more loop elements or patches 76 attached to the outer surface of outer cover 62 in the front waistband region of diaper 60. The loop material for loop patch 76 can be a woven, nonwoven or knitted loop material and may be secured to outer cover 62 of diaper 60 by known attachment means, including but not limited to adhesives, thermal bonding, ultrasonic bonding, or a combination of such means. As an alternative embodiment, a nonwoven loop material may cover all of, or substantially all of, the outer surface of outer cover 62.

While the invention has been described in detail with respect to specific embodiments thereof, it will be apparent to those skilled in the art that various alterations, modifications and other changes may be made to the invention without departing from the spirit and scope of the present invention. It is therefore intended that the claims cover or encompass all such modifications, alterations and/or changes.

1. A composition for a biodegradable, breathable film comprising:
a biodegradable polyester;
a biodegradable copolyester; and
at least one fillers
wherein the weight ratio of polyester to copolyester ranges from about 1:9 to about 9:1.

2. The composition of claim 1, wherein the polyester is polylactic acid.

3. The composition of claim 1, wherein the copolyester is a copolyester of aliphatic/aromatic acids.

4. The composition of claim 1, wherein the filler is calcium carbonate.

5. The composition of claim 2, wherein the polylactic acid is selected from the group consisting of D-polylactic acid, L-polylactic acid, D,L-polylactic acid, meso-polylactic acid, and combinations of D-polylactic acid, L-polylactic acid, D,L-polylactic acid and meso-polylactic acid.

6. The composition of claim 1, further comprising a compatibilizer.

7. The composition of claim 1, comprising from about 30 weight percent to about 70 weight percent polyester and copolyester, and from about 70 weight percent to about 30 weight percent filler.

8. The composition of claim 7, comprising from about 40 weight percent to about 55 weight percent polyester and copolyester, and from about 60 weight percent to about 45 weight percent filler.

9. (canceled)

10. A biodegradable and breathable film comprising a biodegradable polyester, a biodegradable copolyester and a filler, wherein the weight ratio of polyester to copolyester ranges from about 1:9 to about 9:1.

11. The film of claim 10, wherein the polyester is polylactic acid, the copolyester is a copolyester of aliphatic/aromatic acids, and the filler is calcium carbonate.

12. The film of claim 10, which has a breathability value of greater than 3,000 grams per square meter per 24 hours.

13. The film of claim 12, which has a breathability value of greater than 5,000 grams per square meter per 24 hours.

14. The film of claim 10, which is formed by melt blending said polyester, copolyester and filler and cast-forming said film.

15. The film of claim 10, which is formed by melt blending said polyester, copolyester and filler and blow-forming said film.

16. The film of claim 10, which is stretched in at least a monoaxial direction.

17. The film of claim 10, which is biaxially stretched.

18. The film of claim 10 further comprising at least one additional layer bonded thereto.

19. A disposable article of manufacture comprising a film according to claim 10.

20. The disposable article of claim 19, which is selected from the group consisting of medical products, protective garments and personal care absorbent articles.
